(19) United States
(12) Patent Application Publication
(10) Pub. No.: US 2013/0010217 A1
(43) Pub. Date: Jan. 10, 2013

(54) LIQUID CRYSTAL DISPLAY

(75) Inventor: Chihtsung Kang, Guangdong (CN)

(73) Assignee: SHENZHEN CHINA STAR OPTOELECTRONICS TECHNOLOGY CO., LTD., Guangdong (CN)

(21) Appl. No.: 13/378,266

(22) PCT Filed: Aug. 25, 2011
(86) PCT No.: PCT/CN2011/078951

§ 371 Date: Dec. 14, 2011

(30) Foreign Application Priority Data
Jul. 8, 2011 (CN) 201110190916.4

(51) Int. Cl. G02F 1/1335

(52) U.S. Cl. 349/15

(57) ABSTRACT

A liquid crystal display is disclosed, comprising a TFT-LCD module and its corresponding phase retarder, where the pixels of the TFT-LCD module applies a first display mode which comprises left-eye signal pixels, black matrix signal pixels, right-eye signal pixels and black matrix signal pixels that are horizontally arranged in a cyclical manner. The left-eye signal pixels and its corresponding black matrix signal pixels employ one type of phase retarder to emit a polarized signal while the right-eye signal pixels and its corresponding black matrix signal pixels employ the other type of phase retarder to emit the other polarized signal. By modifying pixel signals emitted by the TFT-LCD module of the liquid crystal display of the present invention, the elimination of the crosstalk at viewing three-dimensional images or the darkened luminance at viewing two-dimensional images can be achieved.

### BACKGROUND OF THE INVENTION

1. Field of the Invention

The present invention relates to a liquid crystal display. More particularly, the present invention relates to a liquid crystal display that features reduction on crosstalk among pixels and shows no effect on its 2-dimensional display.

2. Description of the Prior Art

With the advancement of 3D techniques, the demand for viewing 3D movies by means of 3D displays is getting more popular. The cross-section of a frequently seen glasses-type 3D liquid crystal display is shown in FIG. 1, where the liquid crystal display comprises a thin film transistor-liquid crystal display (TFT-LCD) module and a phase retarder. The pixel signals of such 3D liquid crystal display panel from top to down are left-eye signal followed by right-eye signal in a cyclical manner, which enables the displayed signals of the display to be interlaced one line with the other horizontally that are perceived by the left and right eyes, shown in FIG. 2.

The phase retarder is attached to the front of the TFT-LCD module. According to the pixel signals of the display from top to down where the left-eye signal is followed by the right-eye signal in a cyclical manner, the phase sequence that have passed the phase retarder provide different phase offsets to the left eye and the right eye, which enables the left-eye signal and the right-eye signal of the same vertical polarization emitted from the TFT-LCD module to be converted into different polarized lights to the left eye and the right eye. Shown in FIG. 1, suppose that the polarized state of the light emitted from the TFT-LCD module is a vertical polarization, the pixel signal of the right eye that passes λ/2 wave plate becomes horizontally polarized, while the pixel signal of the left eye that passes zero phase wave plate maintains a vertical polarization. With a further passing through a polarized glass, the left eye signal and the right eye signal are then available to distinguish one from the other.

As shown in FIG. 1, a drawback is existed in the design, which is the restriction for observing in a large viewing angle, where the viewing angle can not exceed ±θ1. Once the viewing angle exceeds ±θ1, the pixel signal of the left eye that passes λ/2 wave plate and the pixel signal of the right eye that passes zero phase wave plate can be observed, which makes the vertically polarized lens originally to observe left eye signal by left eye to further observe simultaneously the vertical right eye signal generated by the pixel signal of the right eye that passes zero phase wave plate due to large elevation angle; and the originally observed right eye signal that passed the horizontally polarized lens of the right eye to further observe simultaneously the horizontal left eye signal generated by the pixel signal of the left eye that passes λ/2 wave plate due to large viewing angle, which generates so-called crosstalk, and that is a dragging phenomenon formed by a high contrast frame profile at its background portion.

FIG. 3 shows a method to improve the crosstalk to the liquid crystal display, which is to place a black matrix between λ/2 wave plate and zero phase wave plate of the original phase retarder, and by shortening the original diameter a of the λ/2 wave plate and zero phase wave plate into b, which makes the angles of the left-eye signal and the right-eye signal after passing the non-correspondent phase retarder become bigger in a large viewing angle and thereby boost the viewing angle of no crosstalk. However, once the liquid crystal display is used to view two dimensional images, the luminance of the liquid crystal display is darkened during displaying two dimensional images, due to the black matrix on the phase retarder,

Accordingly, there is demand for a liquid crystal display to settle the existing problems of present techniques.

### SUMMARY OF THE INVENTION

The objective of the present invention is to provide a liquid crystal display, capable of eliminating the crosstalk at viewing three-dimensional images or the darkened luminance at viewing two-dimensional images.

To settle the aforementioned problems, a technical solution provided by the present invention is as follows:

a liquid crystal display, comprising a TFT-LCD module, and a corresponding phase retarder, where the pixels of the TFT-LCD module comprises: a first display mode which comprises left-eye signal pixels, black matrix signal pixels, right-eye signal pixels and black matrix signal pixels that are horizontally arranged in a cyclical manner; and a second display mode which comprises the black matrix signal pixels, the left-eye signal pixels, the black matrix signal pixels and the right-eye signal pixels that are horizontally arranged in a cyclical manner. The left-eye signal pixels and the corresponding black matrix signal pixels employ one type of phase retarder to emit a polarized signal, while the right-eye signal pixels and the corresponding black matrix signal pixels employ the other type of phase retarder to emit a polarized signal. The TFT-LCD module applies the first display mode and the second display mode alternately and equally in time interval. By means of switching signals of the left-eye signal pixel with signals of the corresponding black matrix signal pixel and switching signals of the right-eye signal pixel with signals of the corresponding black matrix signal pixel, the switching between the first display mode and the second display mode can be accomplished. The phase retarders comprises one combination of a zero phase wave plate and a λ/2 wave plate or a combination of λ/4 wave plates of 45 degree and 135 degree.

A liquid crystal display, comprising a TFT-LCD module and its corresponding phase retarder, where the pixels of the TFT-LCD module applies a first display mode which comprises left-eye signal pixels, black matrix signal pixels, right-eye signal pixels and black matrix signal pixels that are horizontally arranged in a cyclical manner. The left-eye signal pixels and its corresponding black matrix signal pixels employ one type of phase retarder to emit a polarized signal, while the right-eye signal pixels and its corresponding black matrix signal pixels employ the other type of phase retarder to emit a polarized signal.

This invention provides another type of liquid crystal display, comprising a TFT-LCD module and its corresponding phase retarder, where the pixels of the TFT-LCD module applies a second display mode which comprises black matrix signal pixels, left-eye signal pixels, black matrix signal pixels and right-eye signal pixels that are horizontally arranged in a cyclical manner, and the left-eye signal pixels and its corresponding black matrix signal pixels employ one type of phase retarder to emit a polarized signal, while the right-eye signal pixels and its corresponding black matrix signal pixels employ the other type of phase retarder to emit a polarized signal.

In an embodiment of this invention, the TFT-LCD module applies the first display mode and the second display mode alternately and equally in time interval.

In an embodiment of this invention, by means of switching the signals of the left-eye signal pixel with the signals of its corresponding black matrix signal pixel and switching the signals of the right-eye signal pixel with the signals of its corresponding black matrix signal pixel, the switching between the first display mode and the second display mode can be accomplished.

In an embodiment of this invention, the phase retarder comprises a combination made up of a zero phase wave plate and a λ/2 wave plate.

In an embodiment of this invention, the phase retarder comprises a combination made up of a 45 degree and a 135 degree of λ/4 wave plates.

Compared with the present liquid crystal displays that have the crosstalk at viewing three-dimensional images or the darkened luminance at viewing two-dimensional images, the liquid crystal display of this invention achieves substantial improvement in alleviating the crosstalk at viewing three-dimensional images and in eliminating the darkened luminance at viewing two-dimensional images by modifying pixel signals emitted from the TFT-LCD module.

This invention is detailed described with reference to the following preferred embodiments and the accompanying drawings, where the aforementioned contents of this invention can be made more clear and understandable.

### BRIEF DESCRIPTION OF THE DRAWINGS

FIG. 1 is a schematic diagram of the structure of traditional techniques of the liquid crystal display;

FIG. 2 is a schematic diagram of display signals of traditional techniques of the liquid crystal display;

FIG. 3 is a schematic diagram of the structure of black matrix on a phase retarder of traditional techniques of the liquid crystal display;

FIG. 4 is a schematic diagram of the structure of a first preferred embodiment of the liquid crystal display of this invention;

FIG. 5 is a schematic diagram of displayed signals of a first preferred embodiment of the liquid crystal display of this invention;

FIG. 6 is a schematic diagram of the structure of a second preferred embodiment of the liquid crystal display of this invention; and

FIG. 7 is a schematic diagram of displayed signals of a second preferred embodiment of the liquid crystal display of this invention.

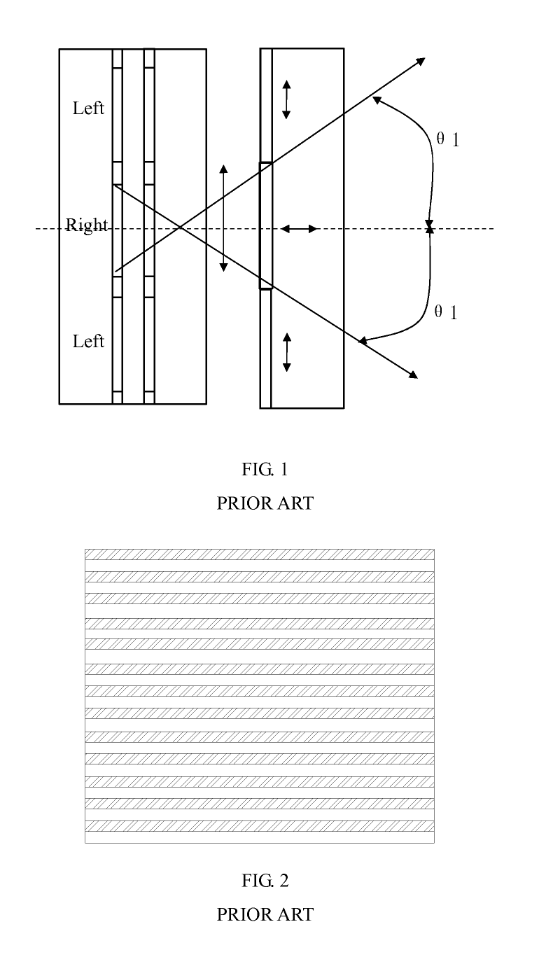

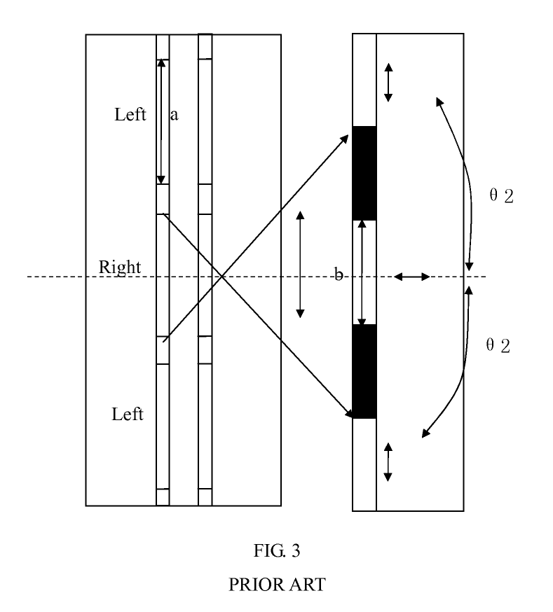

### DETAILED DESCRIPTION OF THE INVENTION

The following embodiments are described with reference to the following accompanying drawings, which exemplify the realization of this invention. The directional terminologies of this invention, for instance: top, bottom, front, back, left, right, inner, outer, side and the like are merely the direction with reference to the accompanying drawings. Therefore, the aforesaid directional terminologies are used to describe and comprehend this invention, instead of limiting this invention.

In the following drawings, objects in similar structure are marked by same numerals.

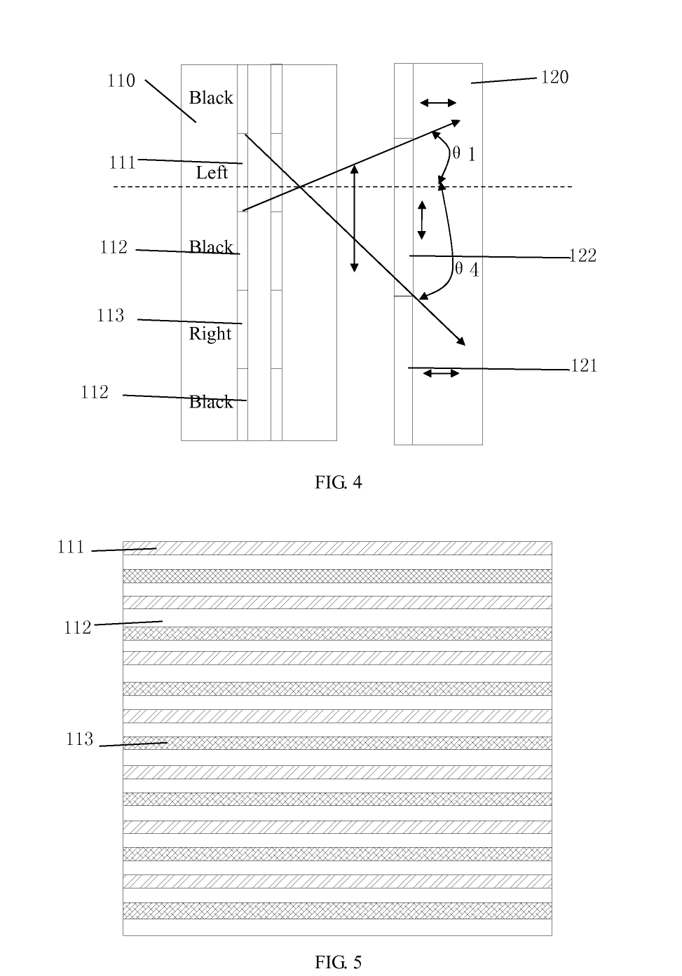

As the first preferred embodiment of this invention, the liquid crystal display of this invention shown in FIG. 4 comprises a TFT-LCD module 110 and its corresponding phase retarder 120, the pixels of the TFT-LCD module applies a first display mode which comprises left-eye signal 111 pixels, black matrix signal 112 pixels, right-eye signal 113 pixels and black matrix signal 112 pixels that are horizontally arranged in a cyclical manner, and the left-eye signal 111 pixels and the corresponding black matrix signal 112 pixels employ one type of phase retarder 122 to emit a polarized signal, while the right-eye signal 113 pixels and the corresponding black matrix signal 112 pixels employ the other type of phase retarder 121 to emit the other polarized signal.

The size of exchangeable different type phase retarders 120 of this invention is designed according to the size of the pixel of an image signal (left-eye signal or right-eye signal) and the size of the pixel of a corresponding black matrix signal 112, shown in FIG. 4, a similar type of phase retarder 122 corresponds to two pixels (left-eye signal 111 pixel and black matrix signal 112 pixel), which means double the size of present phase retarder shown in FIG. 1. In FIG. 4, suppose that the polarization of the emitted light of TFT-LCD module 110 is vertically polarized, the left-eye signal 111 observed by a top viewing angle is same to that shown in FIG. 1, where the viewing angle still cannot exceed θ1. The reason is that the left-eye signal 111 is supposed to pass zero phase wave plate 122 to generate a vertically polarized signal; however, as the observed viewing angle exceeds θ1, the left-eye signal 111 will pass the λ/2 wave plate 121 to generate a horizontally polarized signal which gives rise to the crosstalk of the left-eye signal 111 to right-eye polarized lens. Since the zero phase wave plate 122 has doubled the original area, the angle of observing the left-eye signal 111 by a bottom viewing angle can achieve a large viewing angle θ4, where θ4>>θ1. The displayed signals of the liquid crystal display of this invention are arranged in a horizontally cyclical manner, as shown in FIG. 5, the left-eye signal and the right-eye signal each is followed by a black matrix signal in a cyclical manner.

As viewing 3D display screen by the liquid crystal display of this invention, the bottom viewing angle can be a vertical large viewing angle which suffers no crosstalk and thereby alleviates the effects by the crosstalk at viewing 3D images, and the luminance of 2D images is not affected due to no black matrix on the phase retarder 120 at viewing 2D images.

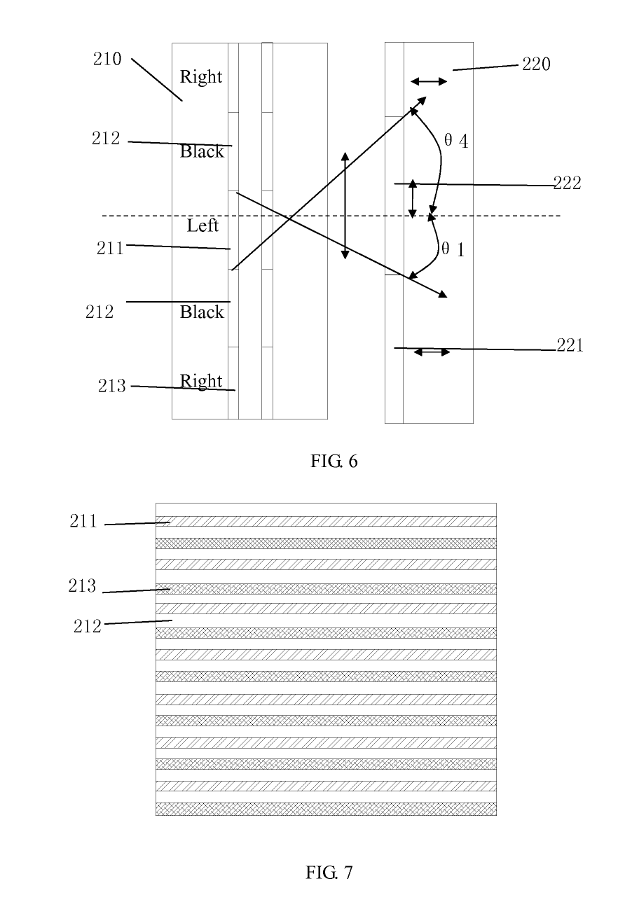

As the second preferred embodiment of this invention, the liquid crystal display shown in FIG. 6 comprises a TFT-LCD module 210 and its corresponding phase retarder 220, the pixels of the TFT-LCD module applies a second display mode which comprises black matrix signal 212 pixels, left-eye signal 211 pixels, black matrix signal 212 pixels and right-eye signal 213 pixels that are horizontally arranged in a cyclical manner, and the left-eye signal 211 pixels and the corresponding black matrix signal 212 pixels employ one type of phase retarder 222 to emit a polarized signal while the right-eye signal 213 pixels and the corresponding black matrix signal 212 pixels employ the other type of phase retarder 221 to emit the other polarized signal.

The size of exchangeable different type phase retarders 220 of this invention is designed according to the size of the pixel of an image signal (left-eye signal or right-eye signal) and the size of the pixel of a corresponding black matrix signal 212, shown in FIG. 6, a similar type of phase retarder 222 corresponds to two pixels (left-eye signal 211 pixel and black matrix signal 212 pixel), which means double the size of present phase retarder shown in FIG. 1. In FIG. 6, suppose that the polarization of the emitted light of TFT-LCD module 210 is vertically polarized, the left-eye signal 211 observed by a top viewing angle is same to that shown in FIG. 1, and the viewing angle still can not exceed θ1. The reason is that the left-eye signal 211 is supposed to pass zero phase wave plate 222 to generate a vertically polarized signal; however, as the observed viewing angle exceeds θ1, the left-eye signal 211 will pass the λ/2 wave plate 221 to generate a horizontally polarized signal which gives rise to the crosstalk of the left-eye signal 211 to right-eye polarized lens. Since the zero phase wave plate 222 has doubled the original area, the angle of observing the left-eye signal 211 by a bottom viewing angle can be achieved to a large viewing angle θ4, where θ4>>θ1. The displayed signals of the liquid crystal display of this invention are arranged in a horizontally cyclical manner, as shown in FIG. 7, the left-eye signal and the right-eye signal each is followed by a black matrix signal in a cyclical manner.

As viewing 3D display screen by the liquid crystal display of this invention, the top viewing angle can be a vertically large viewing angle which suffers no crosstalk and thereby alleviates the effects by the crosstalk at viewing 3D images, and the luminance of 2D images is not affected due to no black matrix on the phase retarder 220 at viewing 2D images.

As the third preferred embodiment of this invention, the pixels of the TFT-LCD module comprises a first display mode where left-eye signal pixels, black matrix signal pixels, right-eye signal pixels and black matrix signal pixels that are horizontally arranged in a cyclical manner; and a second display mode where black matrix signal pixels, left-eye signal pixels, black matrix signal pixels, right-eye signal pixels that are horizontally arranged in a cyclical manner. The TFT-LCD module applies the first display mode and the second display mode alternately and equally in time interval. By means of switching the signals of the left-eye signal pixel with the signals of the corresponding black matrix signal pixel and switching the signals of the right-eye signal pixel with the signals of the corresponding black matrix signal pixel, the switching between the first display mode and the second display mode can be accomplished.

The display principle for the first display mode and the second display mode are the same as that of the first preferred embodiment and the second preferred embodiment respectively, and the details are referring to the above preferred embodiments. In this embodiment, the first display mode and the second display mode are alternate to display in an equal time interval. By means of switching the signals of the left-eye signal pixel with that of the corresponding black matrix signal pixel and switching the signals of the right-eye signal pixel with that of the corresponding black matrix signal pixel, the switching between display modes can be realized, which enables the observed angle of the viewing of 3D images, despite a top viewing angle or a bottom viewing angle, can achieve a large viewing angle θ4, available to alleviate the effects of the crosstalk. Therefore, the left-eye and right-eye signals will pass the polarized glass in a half time without the suffering from the crosstalk, while the second half time the observed screen will suffer the effects by the crosstalk. And it means the effect by the crosstalk has down to half of the original effect, which substantially achieves the purpose of alleviating the effect by the crosstalk.

As preferred embodiments of the liquid crystal display of this invention, the phase retarders are either a combination of zero phase wave plate and λ/2 wave plate or a combination of a 45 degree and a 135 degree of slow axis for λ/4 wave plates. Once the combination of a zero phase wave plate and a λ/2 wave plate is selected, a glasses with horizontal polarization absorption on one side while vertical polarization absorption on the other side is selected to achieve 3D image display purpose. On the other hand, the combination of a 45 degree and a 135 degree of slow axis for λ/4 wave plates is selected, a glasses with left-handed polarization absorption on one side while right-handed polarization absorption on the other side is selected to achieve 3D image display purpose. The user may select adequate wave plate combination to generate left-eye and right-eye polarized signals based on demands.

In general, although a few embodiments of the present invention have been disclosed, the above preferred embodiments are not used for limiting this invention, and it will be understood by those of ordinary skill in the art that various changes in form and details may be made therein without departing from the spirit and scope of the present invention.

What is claimed is:

1. a liquid crystal display, comprising a TFT-LCD module and a corresponding phase retarder thereof, characterized in that: pixels of the TFT-LCD module comprises: a first display mode which comprises left-eye signal pixels, black matrix signal pixels, right-eye signal pixels and black matrix signal pixels that are horizontally arranged in a cyclical manner; and a second display mode: the black matrix signal pixels, the left-eye signal pixels, the black matrix signal pixels and the right-eye signal pixels that are horizontally arranged in a cyclical manner, wherein the left-eye signal pixels and the corresponding black matrix signal pixels employ one type of phase retarder to emit a polarized signal, while the right-eye signal pixels and the corresponding black matrix signal pixels employ the other type of phase retarder to emit the other polarized signal;
the TFT-LCD module applies the first display mode and the second display mode alternately and equally in time interval;
by means of switching the signal of the left-eye signal pixel with the signal of the corresponding black matrix signal pixel and switching the signal of the right-eye signal pixel with the signal of the corresponding black matrix signal pixel, the switching between the first display mode and the second display mode is accomplished;
the phase retarders comprise one combination of a zero phase wave plate and a λ/2 wave plate or a combination of λ/4 wave plates of 45 degree and a 135 degree of slow-axis.

2. A liquid crystal display, comprising a TFT-LCD module and a corresponding phase retarder thereof, characterized in that: pixels of the TFT-LCD module comprises: a first display mode which comprises left-eye signal pixels, black matrix signal pixels, right-eye signal pixels and black matrix signal pixels that are horizontally arranged in a cyclical manner, wherein the left-eye signal pixels and its corresponding black matrix signal pixels employ one type of phase retarder to emit a polarized signal while the right-eye signal pixels and its corresponding black matrix signal pixels employ the other type of phase retarder to emit the other polarized signal.

3. The liquid crystal display as claimed in claim 2, characterized in that: the pixels of the TFT-LCD module further comprises a second display mode which comprises the black matrix signal pixels, the left-eye signal pixels, the black matrix signal pixels and the right-eye signal pixels that are horizontally arranged in a cyclical manner.

4. The liquid crystal display as claimed in claim 3, characterized in that: the TFT-LCD module applies the first display mode and the second display mode alternately and equally in time interval.

5. The liquid crystal display as claimed in claim 4, characterized in that: by means of switching the signal of the left-eye signal pixel with the signal of the corresponding black matrix signal pixel and switching the signal of the right-eye signal pixel with the signal of the corresponding black matrix signal pixel, the switching between the first display mode and the second display mode is accomplished.

6. The liquid crystal display as claimed in claim 2, characterized in that: the phase retarders comprise a combination of a zero phase wave plate and a λ/2 wave plate.

7. The liquid crystal display as claimed in claim 2, characterized in that: the phase retarders comprise a combination of λ/4 wave plates of 45 degree and 135 degree of slow-axis.

8. The liquid crystal display as claimed in claim 4, characterized in that: the phase retarders comprise a combination of a zero phase wave plate and a λ/2 wave plate or a combination of λ/4 wave plates of 45 degree and 135 degree of slow-axis.

9. A liquid crystal display, comprising a TFT-LCD module and a corresponding phase retarder thereof, characterized in that: pixels of the TFT-LCD module comprises: a second display mode which comprises black matrix signal pixels, left-eye signal pixels, black matrix signal pixels and right-eye signal pixels that are horizontally arranged in a cyclical manner, wherein the left-eye signal pixels and its corresponding black matrix signal pixels employ one type of phase retarder to emit a polarized signal while the right-eye signal pixels and its corresponding black matrix signal pixels employ the other type of phase retarder to emit a polarized signal.

10. The liquid crystal display as claimed in claim 9, characterized in that: the pixels of the TFT-LCD module further comprises a first display mode which comprises left-eye signal pixels, black matrix signal pixels, right-eye signal pixels and black matrix signal pixels that are horizontally arranged in a cyclical manner.

11. The liquid crystal display as claimed in claim 10, characterized in that: the TFT-LCD module applies the first display mode and the second display mode alternately and equally in time interval.

12. The liquid crystal display as claimed in claim 11, characterized in that: by means of switching the signal of the left-eye signal pixel with the signal of the corresponding black matrix signal pixel and switching the signal of the right-eye signal pixel with the signal of the corresponding black matrix signal pixel, the switching between the first display mode and the second display mode is accomplished.

13. The liquid crystal display as claimed in claim 9, characterized in that: the phase retarders comprise a combination of a zero phase wave plate and a λ/2 wave plate.

14. The liquid crystal display as claimed in claim 9, characterized in that: the phase retarders comprise a combination of λ/4 wave plates of 45 degree and 135 degree of slow-axis.

15. The liquid crystal display as claimed in claim 11, characterized in that: the phase retarders comprises a combination of a zero phase wave plate and a λ/2 wave plate or a combination of λ/4 wave plates of 45 degree and 135 degree of slow-axis.
